(19) United States
(12) Patent Application Publication
(10) Pub. No.: US 2026/0092162 A1
(43) Pub. Date: Apr. 2, 2026

(54) NITROGEN-CONTAINING COMPOUNDS PLASTICSED BIODEGRADABLE THERMOPLASTIC STARCH COMPOSITION AND PREPARATION METHOD THEREOF

(71) Applicant: NANO AND ADVANCED MATERIALS INSTITUTE LIMITED, HONG KONG (CN)

(72) Inventors: Calvin Chun Long CHEUNG, HONG KONG (CN); Bin XIAO, HONG KONG (CN)

(73) Assignee: NANO AND ADVANCED MATERIALS INSTITUTE LIMITED, HONG KONG (CN)

(21) Appl. No.: 18/900,933

(22) Filed: Sep. 30, 2024

(51) Int. Cl. C08K 5/21; B65D 65/46; C08B 30/00; C08K 5/053; C08K 5/19; C08K 5/3415

(52) U.S. Cl. CPC C08K 5/21; B65D 65/466; C08B 30/00; C08K 5/053; C08K 5/19; C08K 5/3415

(57) ABSTRACT

The present disclosure provides a novel and biodegradable thermoplastic starch composition and a preparation method thereof. Compared to conventional thermoplastic starch materials, the thermoplastic starch composition of the present disclosure shows enhanced mechanical strength, improved stability and resistance to retrogradation, and is able to maintain their biodegradability with no need for blending with fossil-based plastics.

### BACKGROUND

### Technical Field

The present disclosure relates to the field of biodegradable materials. More particularly, it relates to marine degradable, thermoplastic starch materials and the preparation method thereof.

### Description of Related Art

To attain environmental sustainability and reduce anthropogenic carbon emissions, the use of bio-based polymer is highly favorable. Thermoplastic starch is the most widely used bioplastics, for its abundant and renewable sources, low production cost, minimal bio-/eco-toxicity, and high compatibility with existing plastic machining processes such as extrusion, injection molding and thermoforming.

Thermoplastic starch is also rapidly biodegradable in natural environment such as soil or marine, in contrast to conventionally bio-based plastics that are essentially non-biodegradable (bio-based analogue of fossil-based plastics) or require specific conditions for degradation (e.g. elevated temperature and specific microorganisms).

The conversion of starch into thermoplastic starch is achieved through plasticization (or sometimes gelatinization) in which plasticizers are introduced to break down the native intermolecular and intramolecular hydrogen bond of starch molecules. At the best of knowledge, most thermoplastic starch formulations utilize polyols as plasticizer, due to the ability of hydroxyl groups in polyols to participate in starch hydrogen bond networks. Typical polyol plasticizers include glycerol, sugar alcohols, glycols and related derivatives. For example, US20130158169A1 discloses the use of polyols as plasticizer in thermoplastic starch composition. The inclusion of other thermoplastic polymers such as polyolefins in the composition decreased the biodegradability and biomass content of the resultant compositions. U.S. Pat. Nos. 4,900,361A and 5,405,564A disclose thermoplastic starch compositions with plasticizers such as glycerol, propylene glycol, sorbitol and triethyl citrate. U.S. Pat. No. 5,449,708A disclosed the use of polyols such as glycerol, sorbitol or ethylene glycol as plasticizer in thermoplastic starch composition. CN1063699A disclosed the use of polyols such as glycerol, sorbitol and related derivatives as plasticizer in thermoplastic starch compositions.

Despite the advantages of thermoplastic starch, its relatively low mechanical strength and poor water resistance are the main barrier to its wider uses. As the hydrogen bond networks formed between polyols and starch are relatively weak and inextensive, resulting in low mechanical strength and retrogradation (migration and loss of plasticizers) after long-term storage of the thermoplastic starch. Hence, thermoplastic starch is often employed in form of polymer blend, where other compositions such as low density polyethylene, high density polyethylene and polypropylene are incorporated to enhance mechanical strength and stability at the expense of biodegradability.

Thus, a thermoplastic starch composition with improved mechanical strength and stability is necessary in the art.

### SUMMARY

The present disclosure seeks to address the drawbacks of thermoplastic starch compositions in the prior art. The inventors screened a nitrogen-containing compound and a deep eutectic system, as a plasticizer, capable of providing the thermoplastic starch composition with enhanced mechanical strength, stability, and hydrophobicity, and thereby achieved the present disclosure.

As a first aspect of the present disclosure, provided is a thermoplastic starch composition, including:
100 parts by weight of at least one starch-based material; and
1-30 parts by weight of at least one nitrogen-containing plasticizer, the nitrogen-containing plasticizer is a compound or deep eutectic system having at least three nitrogen atoms.

As a second aspect of the present disclosure, provided is a thermoplastic composite, formed by compounding a thermoplastic starch composition according to the first aspect and a fossil-based plastic.

As a third aspect of the present disclosure, provided is a food-contactable product made from a thermoplastic starch composition according to the first aspect or a thermoplastic composite according to the second aspect, the food contact product is in comply with standards GB/T 41220, GB/T 10457, GB/T 18006 or GB/T 10004.

The present disclosure employs the hydrogen bonding formed between at least three nitrogen atoms in a nitrogen-containing compound or deep eutectic system and the hydroxyl groups of starch, which is stronger and more extensive than that formed between oxygen and hydrogen atoms, to construct new thermoplastic starch compositions. The thermoplastic starch composition of the present disclosure shows enhanced mechanical strength, hydrophobicity, resistance to retrogradation and improved stability, with no need for blending with fossil-based plastics.

The thermoplastic starch composition of the present disclosure is environmentally friendly, due to a fact that the thermoplastic starch compositions are able to maintain their biodegradability, especially in marine environments, in water, in soil and in compost with no need for fossil-based plastics. Without wishing to be bound by theory, the thermoplastic starch composition of the present disclosure can be further compounded with fossil-based plastics as desired, thereby obtaining the thermoplastic composite with increased mechanical strength, ductility, thermodynamic stability and waterproofness, and thus arriving at a wider range of applications.

In the case of incorporating a direct food-contactable plasticizer defined by the present disclosure, the thermoplastic starch composition of the present disclosure may be manufactured into food-contactable products in compliance with the standards GB/T 41220, GB/T 10457, GB/T 18006 or GB/T 10004. The food-contactable products may be, but not limited to, food-packaging boxes, tableware, cover for food packaging, cling films for food, and plastic composite film for packaging.

### BRIEF DESCRIPTION OF THE DRAWINGS

The accompanying drawings are included to provide a further understanding of the disclosure and are incorporated in and constitute a part of this specification. The drawings described herein are for illustration purposes only and are not intended to limit the scope of the disclosure in any way.

FIG. 1 illustrates the process for forming the urea-choline chloride deep eutectic solvent (DES) according to one embodiment of the present disclosure.

FIG. 2 illustrates stress/strain curve of the thermoplastic starch composition according to one embodiment of the present disclosure.

FIG. 3 illustrates the appearance of comparative example C1 of the thermoplastic starch composition before and after 60 days of storage.

FIG. 4 illustrates the appearance of the thermoplastic starch composition N3 according to one embodiment of the present disclosure before and after 7 months of storage.

FIG. 5A illustrates the water contact angles of the thermoplastic starch composition C1, FIG. 5B illustrates the water contact angles of the thermoplastic starch composition C2, FIG. 5C illustrates the water contact angles of the thermoplastic starch composition N5, and FIG. 5D illustrates the water contact angles of the thermoplastic starch composition N6 according to one embodiment of the present disclosure.

### DESCRIPTION OF THE EMBODIMENTS

The following detailed description is merely exemplary in nature and is in no way intended to limit the present disclosure or its application or uses.

Notwithstanding that the numerical ranges and parameters setting forth the broad scope of the disclosure are approximations, the numerical values set forth in the specific examples are reported as precisely as possible. Any numerical value, however, inherently contains certain errors necessarily resulting from the standard variation found in their respective testing measurements.

Also, it should be understood that any numerical range recited herein is intended to include all sub-ranges subsumed therein. For example, a range of “1 to 10” is intended to include all sub-ranges between (and including) the recited minimum value of 1 and the recited maximum value of 10, that is, having a minimum value equal to or greater than 1 and a maximum value of equal to or less than 10.

The terminology used herein is for the purpose of describing particular example embodiments only and is not intended to be limiting.

As used herein, “a”, “an”, “the”, “at least one” and “one or more” are used interchangeably to indicate that at least one of the specified elements, materials, ingredients or method steps is present, unless the context clearly indicates otherwise.

As used herein, the expressions “a/the first”, “a/the second”, “a/the third” and the like are only for the purpose of distinction, but not seek to define any order, priority, or grade.

As used herein, the terms “about” and “substantially” are used herein with respect to measurable values and ranges due to expected variations known to those skilled in the art (e.g., limitations and variability in measurements). The term “about” also indicates that the stated numerical value allows some slight imprecision (with some approach to exactness in the value; approximately or reasonably close to the value; nearly). If the imprecision provided by the term “about” is not otherwise understood in the art with this ordinary meaning, then the term “about” as used herein indicates at least variations that may arise from ordinary methods of measuring and using such parameters. In addition, disclosure of ranges includes disclosure of all values and further divided ranges within the entire range.

As used herein, the term “including”, “containing” and the like terms, together with their grammatical variations, are synonymous with the term “comprising” and its grammatical variations. The term “comprising” and its grammatical variations are open-ended and shall be understood in the context of the present disclosure to include not only the specified elements, materials, ingredients or method steps, but also additional unspecified elements, materials, ingredients or method steps.

As used herein, the term “consisting of” and its grammatical variations should be understood in the context of the present disclosure to exclude the presence of any unspecified element, ingredient or method step. As used herein, the term “consisting essentially of” and its grammatical variations should be understood in the context of the present disclosure to include the specified elements, materials, ingredients or method steps and those that do not materially affect the basic and novel characteristic(s) of what is being described. It shall be understood that, when the term “comprising” and its grammatical variations are used and no additional elements, materials, ingredients or method steps that may materially affect the basic and novel characteristic(s) of what is being described are included, then the term “comprising” can be replaced with the term “consisting of” or “consisting essentially of” and their grammatical variations.

Whereas specific aspects of the disclosure is going to be described in detail, it will be appreciated by those skilled in the art that various modifications and alternatives to those details could be developed in light of the overall teachings of the disclosure. Accordingly, the particular arrangements disclosed are meant to be illustrative only and not limiting as to the scope of the disclosure which is to be given the full breadth of the claims appended and any and all equivalents thereof.

As mentioned above, the present disclosure aims to provide a thermoplastic starch composition, which shows enhanced mechanical strength, stability and hydrophobicity, while remaining the biodegradability, especially in a marine environment, in water, in soil and in a compost environment.

### Thermoplastic Starch Composition

In the context of the present disclosure, it is understood that the term “thermoplastic starch composition” refers to a starch-based composition that reversibly softens under heat and hardens by cooling. It has at least one glass transition temperature (Tg) below which the amorphous portion of the composition is in a brittle glassy state and above which the composition may undergo reversible plastic deformation. The thermoplastic starch compositions of the present disclosure could be manufactured by conventional methods for plastics processing, such as extrusion, injection molding, molding, blow molding, rolling and the like.

As a first aspect of the present disclosure, provided is a thermoplastic starch composition, including:
100 parts by weight of at least one starch-based material; and
1-30 parts by weight of at least one nitrogen-containing plasticizer, the nitrogen-containing plasticizer is a compound or deep eutectic system having at least three nitrogen atoms.

In a particular embodiment, the thermoplastic starch composition of the present disclosure includes a biobased carbon content higher than 60% according to the standards ASTM D6866 or EN 16640.

In a further particular embodiment, the thermoplastic starch composition of the present disclosure includes a biobased carbon content higher than 100% according to the standards ASTM D6866 or EN 16640.

In another particular embodiment, the thermoplastic starch composition of the present disclosure includes a bio-based content of more than 60% according to the standard EN 16785-1.

In a particular embodiment, the thermoplastic starch composition of the present disclosure is biodegradable, especially in a marine environment, in water, in soil or in a compost environment. As mentioned above, the thermoplastic starch composition of the present disclosure shows improved stability, which slows down degradation rate of the thermoplastic starch composition. Nevertheless, a person skilled in the art would understand that this does not inherently change the biodegradability of the starch compositions.

The thermoplastic starch composition of the present disclosure can be prepared using methods well known to those skilled in the art. For example, a mixture including starch and a nitrogen-containing plasticizer is feed into an extruder, passed through the extruder in 20 rpm to 60 rpm at a temperature from 80° C. to 200° C., preferably from 100° C. to 140° C., and then extruded through a die to obtain a biodegradable thermoplastic starch composition.

### Nitrogen-Containing Plasticizer

In the context of the present disclosure, the term “a nitrogen-containing plasticizer” refers to an organic compound or deep eutectic system with at least three nitrogen atoms. The nitrogen atoms are present in the organic compound or deep eutectic system in the form of an amino group, an amine group, an amide group, or the like. The inventors have found that, on the one hand, the hydrogen bond formed between a nitrogen atom in the nitrogen-containing plasticizer and a hydroxyl group of the starch have a higher bond energy than that formed between an oxygen atom (in water and in the polyol) and a hydroxyl group of the starch, which are about 29 KJ/mol for O—H—:N and 29 21 KJ/mol for O—H—:O, respectively; and on the other hand, the multiple nitrogen atoms in the organic compound or the deep eutectic system having at least three nitrogen atoms are capable of forming a plurality of hydrogen bonds, and thereby forming a broader hydrogen bonding network. Thus, the compound or deep eutectic system of the present disclosure having at least three nitrogen atoms as a plasticizer enables the thermoplastic starch composition to have enhanced mechanical strength and stability and to remain biodegradable without no need for blending with fossil-based plastics.

In a particular embodiment, the nitrogen-containing plasticizer may be present at an amount of 5-25 parts by weight, with respect to 100 parts by weight of starch-based material. For example, it may be present at an amount of 6 parts, 7 parts, 8 parts, 9 parts, 10 parts, 11 parts, 12 parts, 13 parts, 14 parts, 15 parts, 16 parts, 17 parts, 18 parts, 19 parts, 20 parts, 21 parts, 22 parts, 23 parts, 24 parts or 25 parts by weight or in any range composed of the above numbers, with respect to 100 parts by weight of starch-based material.

In a particular embodiment, the compound having at least three nitrogen atoms may be one or more selected from a group consisting of arginine, guanidine, diethylenetriamine (DETA), triethylenetetramine (TETA), tetraethylenepentamine (TEPA), 2-cyanoguanidine, bis(urea), melamine, tris(2-aminoethyl)amine (TREN), poly(allylamine) hydrochloride, polyether amine, polyamides.

In a further particular embodiment, the deep eutectic system having at least three nitrogen atoms is urea-based deep eutectic system.

It is worthy noted that in order to avoid affecting the properties of the thermoplastic starch compositions, the nitrogen-containing compounds or deep eutectic systems of the present disclosure do not include carboxylic acids at a pH lower than 5, e.g., lactic acid or citric acid, which may hydrolyze starch.

In another particular embodiment, when the thermoplastic starch composition is intended for food contact applications, the nitrogen-containing plasticizer of the present disclosure may be one or more selected from a group consisting of arginine, guanidine, diethylenetriamine (DETA), and urea-based deep eutectic systems. The thermoplastic starch composition prepared therefrom complies with relevant legal regulations for food products in many countries and regions, including but not limited to, REACH, ROHS, Title 21 of Code of Federal Regulations (21 CFR Part 170-199), Chinese Food Safety Standards issued by the National Health and Safety Commission of China, and the European Union Food Contact Materials Regulation (EC) 1935/2004.

It would be understood that in the case of incorporating the above direct food-contactable plasticizers defined by the present disclosure, the thermoplastic starch composition of the present disclosure may be manufactured into food-contactable and biodegradable products, which are in compliance with the standards GB/T 41220, GB/T 10457, GB/T 18006 or GB/T 10004. The food-contactable and biodegradable products may be, but not limited to, food-packaging boxes, tableware, cover for food packaging, cling films for food, and plastic composite film for packaging.

It would also be understood that when the thermoplastic starch compositions of the present disclosure are not intended for applications as food contact materials, other nitrogen-containing plasticizers such as triethylenetetramine, tetraethylenepentamine, 2-cyano-guanidine, bis(urethane), melamine, tris(2-aminoethyl)amine, poly(allylamine) hydrochloride, polyetheramines, polyamides, and the like may be added into the thermoplastic starch compositions.

### Deep Eutectic System

In the context of the present disclosure, the phrase “deep eutectic system” may also refer to as deep eutectic solvent (DES) or eutectic solvent, which shows similar properties to an ionic liquid, and are in a liquid state at room temperature. A deep eutectic system may be a binary or ternary system, which consists of hydrogen-bonding donors (e.g., polyols, urea and carboxylic acids) and hydrogen-bonding acceptors (quaternary ammonium salts, such as choline chloride, etc.).

In a particular embodiment, the urea-based deep eutectic system may be a binary system including a second compound.

In a further particular embodiment, the second compound may be a quaternary amine compound or a salt thereof, e.g., choline chloride or betaine. As a result, the binary urea-based deep eutectic system of the present disclosure may be urea-choline chloride DES, urea-betaine DES, and the like, but is not limited thereto.

Depending on the particular choice of second compound, those skilled in the art is able to adjust the molar ratio of urea to the second compound to allow the binary system to form a eutectic. In a particular embodiment, the molar ratio of urea to the second compound in the binary system may be in the range of 4:1 to 1:4. In a preferred embodiment, the molar ratio of urea to the second compound in the binary system may be in the range of 2:1 to 1:2.

In a further particular embodiment, the urea-based deep eutectic system may be a ternary system including a second compound and a third compound.

In a particular embodiment, the second compound in the ternary system may be a quaternary amine compound or a salt thereof, such as, but not limited to, choline chloride, betaine, and the like; or an amino acid, such as proline.

In another particular embodiment, third compound may be a polyalcohol selected from the group consisting of sorbitol, glycerol, sucrose, dextrose, but is not limited thereto. As a result, the urea-based deep eutectic system of the ternary of the present disclosure may be, but is not limited to, urea-choline chloride-glycerol DES, urea-choline chloride-sucrose DES, urea-choline chloride-glucose DES, urea-betaine-glycerol DES, urea-sorbitol-prolinol DES, and the like.

Depending on the particular choices of second and third compounds, those skilled in the art is able to adjust the molar ratio of urea, the second compound to the third compound to allow the ternary system to form a eutectic. In a particular embodiment, the molar ratio of the urea, the second compound to the third compound in the ternary system is in the range of 4:1:1 to 1:1:1. In a preferred embodiment, the molar ratio of the urea, the second compound to the third compound in the ternary system is in the range of 3:1:1 to 1:1:1.

The inventors found that use of urea-based DES as plasticizer in the thermoplastic starch composition of the present disclosure further exploits the extensive hydrogen-bonding network of DES to effectively plasticize starch molecules.

The urea-based deep eutectic system of the present disclosure may be prepared by methods well known to those skilled in the art. For example, a specific molar ratio of urea, the second compound (and the third compound) may be by simply mixed and then heated to a temperature of 50° C.-80° C. until the mixture becomes a homogeneous liquid.

### Starch-Based Material

In a particular embodiment, the starch-based material used in the present disclosure is natural starch, modified starch, or any combinations thereof.

In a preferred embodiment, the starch-based material may be a in a preferred embodiment, the starch-based material may be a natural starch.

In a further particular embodiment, the natural starch may be of any plant origin, for example, from cereal plants such as wheat, barley, corn, sorghum; tubers such as potato or cassava; or from legumes such as peas or soybeans, but not limited thereto. The thermoplastic starch compositions of the present disclosure have been shown to be suitable for use with various types of natural starches, e.g., wheat starch, corn starch.

In yet a further particular embodiment, the modified starch may be a starch having a chemical structure different from its native form, modified in a manner including, but not limited to, hydrolysis, cross-linking, esterification, etherification, substitution, redox reaction or any combination thereof. It has been shown that the thermoplastic starch composition of the present disclosure is suitable for various types of modified starches. Exemplary modified starches may be hydroxypropyl di-starch phosphate (TS-HPDSP), but are not limited thereto.

### Oxygen-Containing Plasticizer

In the context of the present disclosure, besides the nitrogen-containing plasticizer, the thermoplastic starch composition of the present disclosure further includes 1-20 parts by weight of oxygen-containing plasticizer, the oxygen-containing plasticizer is a C4-C8 oxygen-containing organic compound selected from the group consisting of acetal, acyl, alcohol, aldehyde, alkoxy, carboxyl, ester, ether, ketone, or any combination thereof.

In a preferred embodiment, the oxygen-containing plasticizer may be present in the thermoplastic starch composition at an amount of 1 parts, 2 parts, 3 parts, 4 parts, 5 parts, 6 parts, 7 parts, 8 parts, 9 parts, 10 parts, 11 parts, 12 parts, 13 parts, 14 parts, 15 parts, 16 parts, 17 parts, 18 parts, 19 parts or 20 parts by weight or in any range composed of the above numbers, with respect to 100 parts by weight of starch-based material.

In a particular embodiment, the oxygen-containing plasticizer is polyols, e.g., selected from the group consisting of glycerol, sorbitol, sugar alcohol, ethylene glycol, diethylene glycol, triethylene glycol, tetraethylene glycol, or any combination thereof.

It is found that the use of oxygen-containing plasticizers can further extend the extensive hydrogen-bonding network, which thereby improves the tensile stress and strain of the thermoplastic starch composition.

### Functional Additives

In the context of the present disclosure, the thermoplastic starch composition of the present disclosure may further include 1-20 parts by weight of one or more functional additives, e.g., selected from a waterproof agent, an antioxidant, a filler, a release agent and the like, but are not limited thereto.

In a preferred embodiment, the functional additives may be present in the thermoplastic starch composition at an amount of 1 parts, 2 parts, 3 parts, 4 parts, 5 parts, 6 parts, 7 parts, 8 parts, 9 parts, 10 parts, 11 parts, 12 parts, 13 parts, 14 parts, 15 parts, 16 parts, 17 parts, 18 parts, 19 parts or 20 parts by weight or in any range composed of the above numbers, with respect to 100 parts by weight of starch-based material.

In a particular embodiment, the waterproof agent may be selected from the group consisting of beeswax, chitin, modified cellulose, lipids, carnauba wax, rice bran wax, soy wax, candelilla wax, fatty acid, Japan wax, paraffin wax, microcrystalline wax, shellac, dimethyl polysiloxane, spermaceti wax, lanolin, petroleum wax, polyethylene wax, or any combination thereof, but are not limited thereto.

It is found that the addition of waterproof agent in the thermoplastic starch composition greatly improves the hydrophobicity of thermoplastic starch, to a water contact angle of about 115°. This is beneficial for starch-based products formed from the thermoplastic starch composition of the present disclosure, e.g., to reduce the adsorption of liquids, e.g. water absorption, of the starch-based products, and thus to minimize liquids from negatively affecting the mechanical properties of the starch-based products.

In another particular embodiment, the antioxidant may be selected from carvacrol, ascorbic acid, tocopherols, tocotrienols, or any combination thereof, but are not limited thereto. It is shown that the addition of the antioxidant to the thermoplastic starch composition reduces the damage to the polymer chains in the thermoplastic starch caused by the heating and pressurization steps of processing, and thereby improves the stability of the thermoplastic starch.

In another particular embodiment, the filler may be selected from bentonite, kaolin, mica, talc, or any combination thereof, but are not limited thereto. It is found that the addition of the fillers to the thermoplastic starch compositions reduces starch coagulation during processing, and prevents the starch or starch compositions from clogging the feed port during feeding.

In another particular embodiment, the release agent may be selected from dimethylpolysiloxane, linoleamide, oleamide, palmitamide, stearamide, or any combination thereof, but are not limited thereto. It is found that the addition of the release agent to the thermoplastic starch composition may lubricate the barrel of the extruder and reduce the friction between the plastic and the barrel, which reduces pyrolysis due to additional warming from the friction and reduces the back pressure on the machine and thus reduces energy consumption.

As a second aspect of the present disclosure, provided is a thermoplastic composite, formed by compounding a thermoplastic starch composition according to the first aspect and a fossil-based plastic.

In a particular embodiment, the fossil-based plastic may be selected from LDPE, PP, PBAT and PBS, but are not limited thereto.

In a preferred embodiment, the fossil-based plastic may be LDPE.

In another particular embodiment, the thermoplastic starch composition and the fossil-based plastic in the thermoplastic composite are in a mole ratio of no less than 1:1, so that the thermoplastic composite thus obtained has enhanced mechanical properties, such as increased mechanical strength, ductility, thermodynamic stability and waterproofness while retaining high starch content, thereby enabling a wider range of applications.

In a further particular embodiment, the thermoplastic starch composition and the fossil-based plastic in the thermoplastic composite are in a mole ratio of 1.1:1, 1.2:1, 1.3:1, 1.4:1, 1.5:1, 1.6:1, 1.7:1, 1.8:1, 1.9:1, 2:1, 3:1, 4:1, 5:1, 6:1, 7:1, 8:1, 9:1 or 10:1 or in any range composed of the above numbers.

In the thermoplastic composite of the present disclosure, the mole ratio of the thermoplastic starch composition to the fossil-based plastic may be determined based on particular choices of the thermoplastic starch composition and the fossil-based plastic. For example, when the fossil-based plastic is LDPE or PBAT, the mole ratio of the thermoplastic starch composition to LDPE or PBAT may be in the range from 1:1 to 2:1, e.g., 50:50 to 65:35 or 60:40 to 65:35.

In the context of the present disclosure, the thermoplastic composite may be prepared by using techniques well known to those skilled in the art, such as film blowing. An exemplary process may be performed as follows: the thermoplastic starch composition and a fossil-based plastic masterbatch are added to a twin-screw extruder heated at 120° C.-180° C. at a screw speed of 30 rpm-60 rpm, and then blown through a die to extend and wind the film.

As a third aspect of the present disclosure, provided is a food-contactable product made from a thermoplastic starch composition according to the first aspect or a thermoplastic composite according to the second aspect.

In a particular embodiment, the food contact product complies with standards GB/T 41220, GB/T 10457, GB/T 18006 or GB/T 10004.

As stated above, in the case of incorporating a direct food-contactable plasticizer defined by the present disclosure, the thermoplastic starch composition of the present disclosure may be manufactured into food-contactable and biodegradable products, such as food-packaging boxes, tableware, and the like. Thus, in a particular embodiment, the food-contactable products may be food-packaging boxes, tableware, cover for food packaging, cling films for food, and plastic composite film for packaging, but are not limited thereto.

### EXAMPLES

Within this specification, examples have been described in a way which enables a clear and concise specification to be written, but it is intended and will be appreciated that examples may be variously combined or separated without parting from the disclosure. For example, it will be appreciated that all preferred features described herein are applicable to all aspects of the disclosure described herein.

### Example 1: Preparation of Urea-Choline Chloride Deep Eutectic Solvent

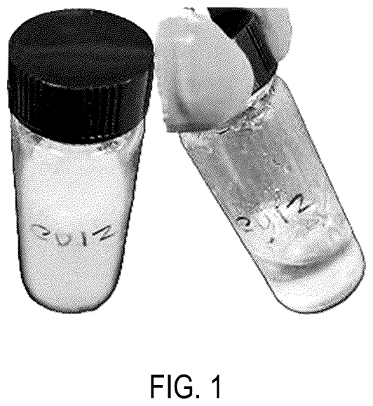

The urea-choline chloride deep eutectic solvent was prepared by mixing urea and choline chloride in a molar ratio of 3:1 and heating to a temperature of about 80° C., stirring until the mixture became a homogeneous liquid without visible solids, as shown in FIG. 1.

### Example 2: Preparation of Thermoplastic Starch Composition

General procedure for preparing the thermoplastic starch composition of the present disclosure includes the steps of: mixing starch, nitrogen-containing plasticizer, oxygen-containing plasticizer, functional additives and the like in a blender at room temperature until a homogeneous solid mixture is obtained; feeding the resulting mixture into an extruder at a temperature of about 100° C. to 140° C. to let the mixture pass through the extruder with a screw speed of 20 rpm to 60 rpm; and then extruding the mixture through a die to obtain the biodegradable thermoplastic starch composition.

The thermoplastic starch compositions of the present disclosure and the comparative examples were prepared according to the above procedure and the components shown in Tables 1 and 2 below, respectively. In this case, the urea-based DES was prepared using the method of Example 1.

TABLE 1
Examples of the thermoplastic starch compositions of the present disclosure

| Components | | | | | | |
|---|---|---|---|---|---|---|
| N1 | N2 | N3 | N4 | N5 | N6 | N7 |
| No. | | | | | | |
| NBM024 | NBM121 | NBM021 | NBM058 | NBM015 | NBM062 | NBM080 |

Starch-based material

| | | | | | | | |
|---|---|---|---|---|---|---|---|
| Corn starch | 100 | 100 | 100 | 100 | | 80 | 100 |
| Wheat starch | | | | | 100 | | |
| TS-HPDSP | | | | | | 20 | |

Nitrogen-containing plasticizer

| | | | | | | | |
|---|---|---|---|---|---|---|---|
| DETA | 5.6 | | | | | | |
| TETA | | | | | | | |
| TEPA | | | | | | | |
| Urea-based DES | | | 18.75 | 18.75 | 22.5 | | 18.75 |
| Arginine | | | | | | 15 | |
| Guanidine | | 25 | | | | | |

Other plasticizers

| | | | | | | |
|---|---|---|---|---|---|---|
| Glycerin | 20 | 6.25 | 6.25 | 7.5 | 10 | 6.25 |

Waterproof agent

| | |
|---|---|
| Beewax | 2 |

Filler

| Calcium carbonate | | | | | | | 3 |
|---|---|---|---|---|---|---|---|
| Silicon dioxide | | | | | | | |
| Stress (Mpa) | 5.8 | 12.83 | 7.58 | 7.67 | 9.13 | 13.4 | 6.61 |
| Strain (%) | 140 | 19 | 75 | 53 | 110 | 74 | 60 |
| WCA (°) | — | | 83.7 | 114.7 | — | — | — |
| Biobased carbon | >90% | 100% | 100% | 100% | 100% | 100% | 100% |
| content | | | | | | | |
| | Components | | | | | | |
| | N8 | N9 | N10 | N11 | N12 | N13 | N14 |
| | No. | | | | | | |
| | NBM083 | NBM076 | NBM074 | NBM025 | NBM026 | NBM113 | NBM115 |

Starch-based material

| | | | | | | | |
|---|---|---|---|---|---|---|---|
| Corn starch | 100 | 100 | 100 | 100 | 100 | 100 | 100 |
| Wheat starch | | | | | | | |
| TS-HPDSP | | | | | | | |

Nitrogen-containing plasticizer

| | | | | | | | |
|---|---|---|---|---|---|---|---|
| DETA | | | | | | | 10 |
| TETA | | | | 7.9 | | | |
| TEPA | | | | | 10.3 | | |
| Urea-based DES | 18.75 | 20 | | | | | |
| Arginine | | | 10 | | | | 15 |
| Guanidine | | | | | | 15 | |

Other plasticizers

| | | | | | |
|---|---|---|---|---|---|
| Glycerin | 6.25 | 15 | 20 | 20 | 10 |

Waterproof agent

Beewax

Filler

| | | | | | | | |
|---|---|---|---|---|---|---|---|
| Calcium carbonate | | | | | | | |
| Silicon dioxide | 3 | | | | | | |
| Stress (Mpa) | 14.28 | 6.85 | 5.23 | 5.19 | 4.67 | 10.38 | 4.29 |
| Strain (%) | 17 | 54 | 91 | 190 | 165 | 31 | 123 |
| WCA (°) | — | | | | | | |
| Biobased carbon | 100% | 100% | 100% | >90% | >90% | 100% | >90% |
| content | | | | | | | |

TABLE 2
Comparative Examples of the thermoplastic starch compositions

| | Components | | | |
|---|---|---|---|---|
| | C1 | C2 | C3 | C4 |
| | No. | | | |
| | NBM005 | NBM023 | NBM003 | NBM006 |
| Corn starch | 100 | 100 | 100 | 100 |
| Urea | | | 15 | |
| Lysine | | | | 15 |
| Glycerin | 15 | 25 | 15 | 15 |
| Sorbitol | 30 | | | |
| Stress (Mpa) | 4.89 | 4.25 | 2.42 | 5.57 |
| Strain (%) | 60 | 67 | 270 | 70 |
| WCA(°) | 70.3 | 68.5 | | — |

### Example 3: Performance Tests of the Thermoplastic Starch Compositions

After the thermoplastic starch compositions were prepared according to the procedure of Example 2, the compositions were subjected to the following performance tests:

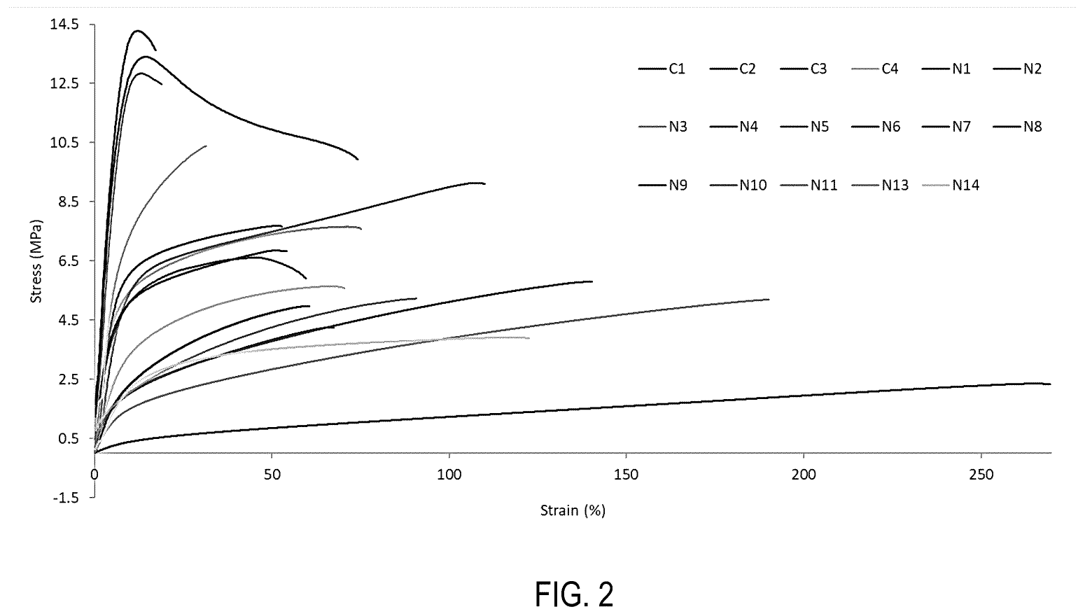

Test for mechanical properties: according to the standard GB/T 1040.2-2022 (type 5A specimen), the thermoplastic starch compositions were tested for mechanical properties, including tensile stress and strain, and the results are shown in Table 1, Table 2 and FIG. 2.

As can be seen from the results in Table 1, Table 2 and FIG. 2, the thermoplastic starch compositions of the present disclosure exhibit higher tensile stresses and/or strains compared to Comparative Examples C1 and C2, which were prepared by using only polyol plasticizers, and C3 and C4, which were prepared by using nitrogen-containing plasticizers. In particular, thermoplastic starch compositions N1, N6 and N8 using guanidine, arginine and urea-based DES as nitrogen-containing plasticizers, respectively, exhibit significant tensile stress; and thermoplastic starch compositions N1, N11 and N12 using diethylenetriamine (DETA), triethylenetetramine (TETA) and tetraethylenepentamine (TEPA), respectively, as nitrogen-containing plasticizers, exhibit enhanced strain. Meanwhile, thermoplastic starch compositions N3-N5, N7 and N9 using urea-based DES as nitrogen-containing plasticizers exhibit a balanced improvement in tensile stress and strain.

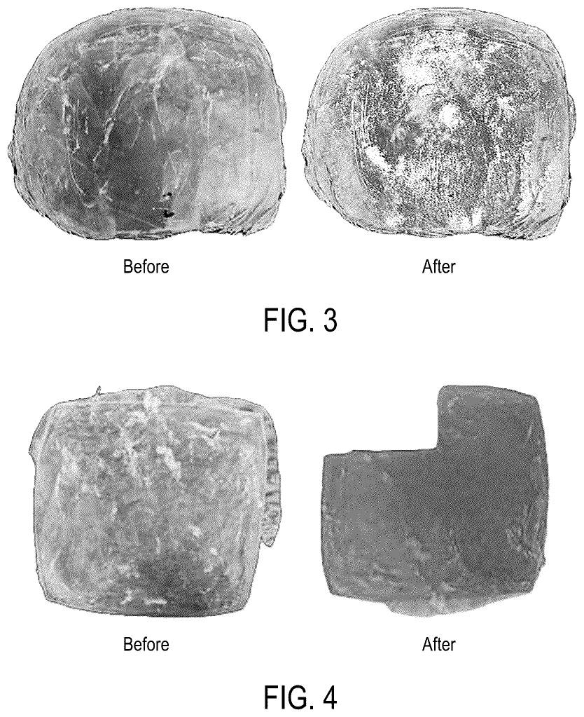

Test for resistance to retrogradation: the thermoplastic starch composition C1 was placed indoors at room temperature (15° C.-25° C.) for 60 days. The appearance changes of the thermoplastic starch composition were observed by the naked eye, and the results are shown in FIG. 3. The thermoplastic starch composition N3 of the present disclosure was placed indoors at room temperature (15° C.-25° C.) for 7 months. The appearance changes of the thermoplastic starch composition were observed by the naked eye, and the results are shown in FIG. 4.

As can be seen from the results of FIGS. 3 and 4, the thermoplastic starch composition C1 showed retrogradation after 60 days with plasticizer release from the surface, which indicates that the starch composition C1 prepared from polyol-based plasticizers has low resistance to retrogradation. In contrast, the thermoplastic starch composition N3 of the present disclosure showed no significant change in the surface appearance after 7 months (the sample was cropped for other tests), demonstrating the significant resistance to retrogradation of the thermoplastic starch composition of the present disclosure.

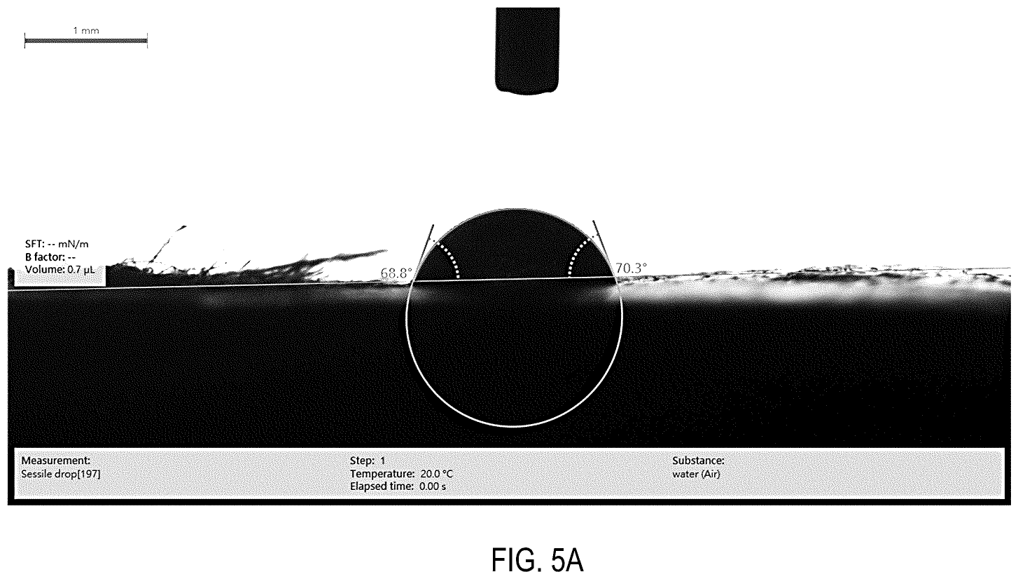

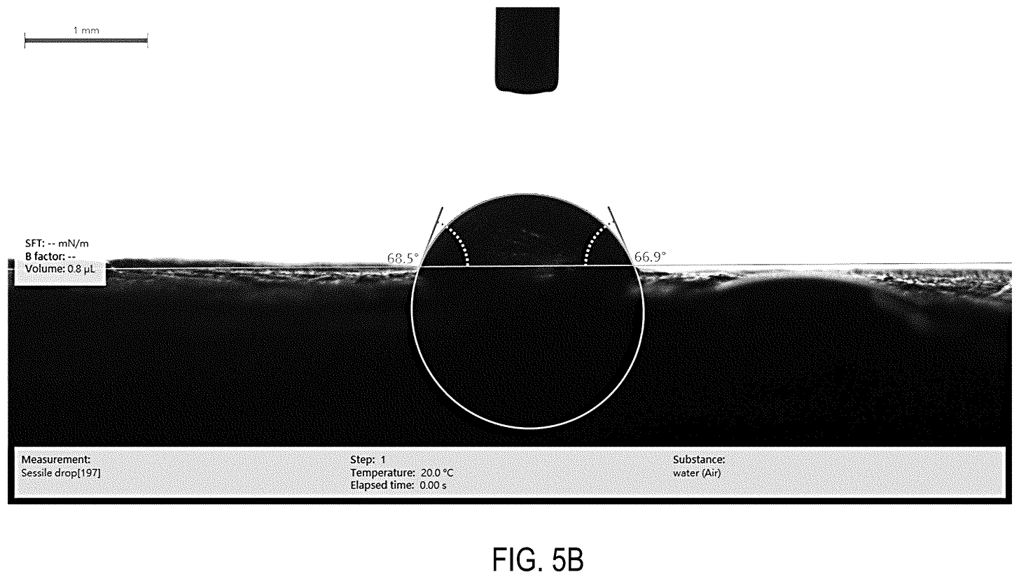

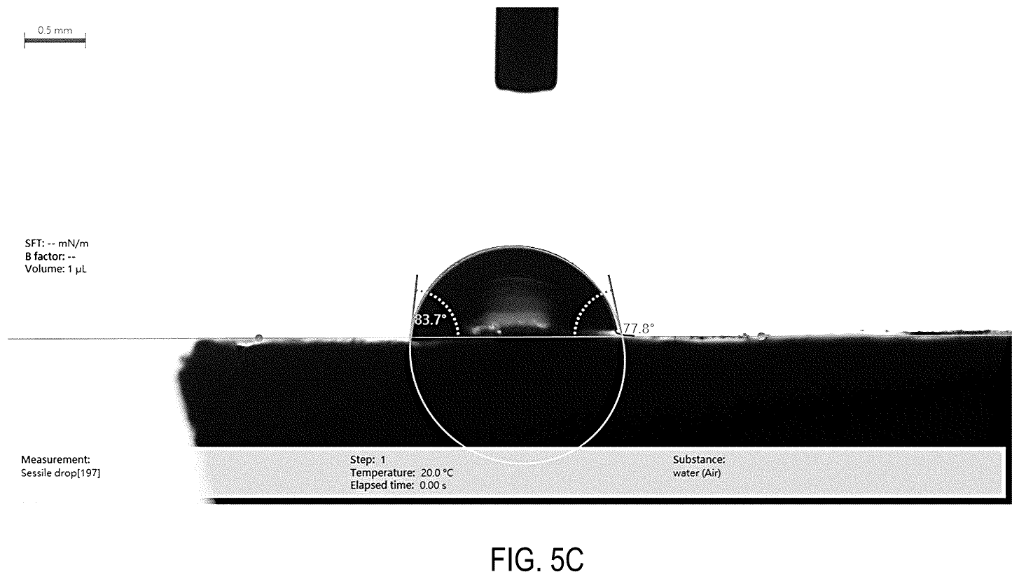

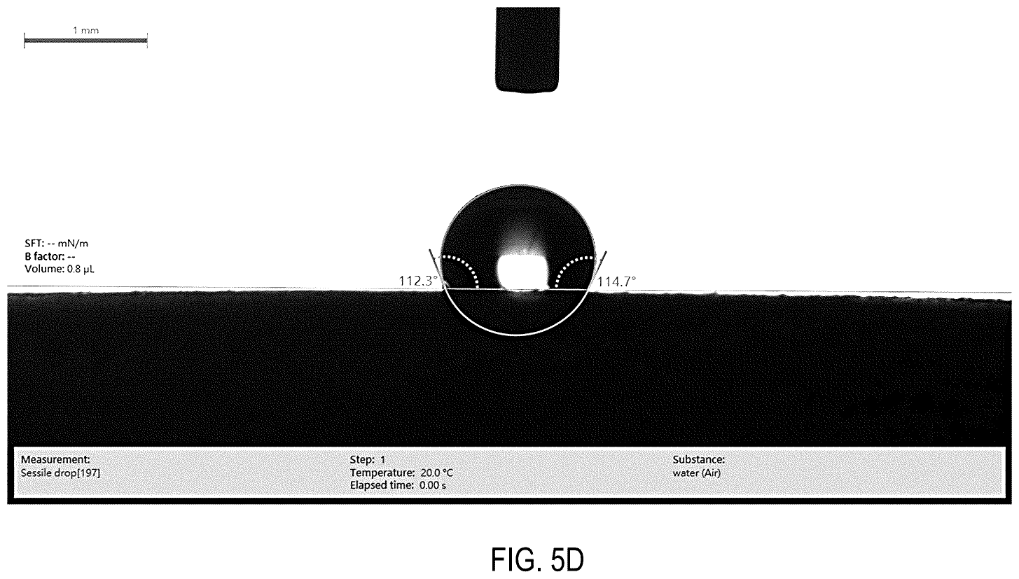

Test for hydrophobicity: The thermoplastic starch compositions C1, C2, N3 and N4 were tested for water contact angle according to the process shown in the ASTM D5946-17 standard. The results are shown in Table 1 and FIGS. 5A-5D.

As can be seen from the results of Table 1 and FIGS. 5A-5D, both the thermoplastic starch compositions N3 and N4 of the present disclosure exhibit a greater water contact angle, i.e., higher hydrophobicity, than the comparative examples C1 and C2, which are prepared from a polyol plasticizer. In addition, composition N4 is significantly improved in terms of the hydrophobicity by the addition of beeswax as a waterproof agent, which achieves a water contact angle of about 115°.

Test for bio-based carbon content: The bio-based carbon content in thermoplastic starch samples N1-N14 were determined by accelerated mass spectrometry (AMS) using radiocarbon dating according to the standard EN 16640. The results are shown in Table 1, where all of the samples N1-N14 of the present disclosure have a bio-based carbon content of >90%, and N2-N10 and N13 even have a bio-based carbon content equal to 100%.

### Example 4: Tests for Biodegradability

Tests for degradability in the marine environment were performed on the thermoplastic starch compositions of the present disclosure according to the standard ISO 23977-1:2020 in the following steps:
1) Seawater and sediments collected from the same sites as the seawater collection sites were used; prior to use, coarse particles were removed from the seawater and, if applicable, from the sediment;
2) The thermoplastic starch composition samples N1-N14 were individually immersed into seawater with sediment and placed in a test flask, ensuring that the concentration of the tested samples N1-N14 is at least 100 mg per liter of seawater (150 mg to 300 mg is preferred) and that the carbon content of the samples N1-N14 is about 60 mg/L;
3) The tests were conducted in the dark or in diffused light, in an enclosure that is free from vapors inhibitory to marine microorganisms and that is maintained at a constant mesophilic temperature; the temperature was controlled between 15° C. and 25° C., but not more than 28° C., to an accuracy of +1° C.;
4) The volatilization of CO₂ from the samples were tested, and the theoretical volatilization of CO₂ (ThCO₂) from the samples were calculated from the molecular formula. The level of biodegradation in the marine environment was determined by comparing the volatilization of carbon dioxide with the theoretical volatilization of carbon dioxide (ThCO₂) and expressed in percentage.

By the method described above, it was determined that all of the samples N1-N14 of the present disclosure had a biodegradation rate of over 90% after 53 days of immersion in the marine environment.

Those skilled in the art, in light of the present disclosure, will appreciate that many changes can be made in the specific embodiments which are disclosed herein and still obtain alike or similar result without departing from or exceeding the spirit or scope of the disclosure. One skilled in the art will further understand that any properties reported herein represent properties that are routinely measured and may be obtained by multiple different methods. The methods described herein represent one such method and other methods may be utilized without exceeding the scope of the present disclosure.

The foregoing description of various forms of the disclosure has been presented for purposes of illustration and description. It is not intended to be exhaustive or to limit the disclosure to the precise forms disclosed. Numerous modifications or variations are possible in light of the above teachings. The forms discussed were chosen and described to provide the best illustration of the principles of the disclosure and its practical application to thereby enable one of ordinary skill in the art to utilize the disclosure in various forms and with various modifications as are suited to the particular use contemplated. All such modifications and variations are within the scope of the disclosure as determined by the appended claims when interpreted in accordance with the breadth to which they are fairly, legally, and equitably entitled.

What is claimed is:

1. A thermoplastic starch composition, comprising:
100 parts by weight of at least one starch-based material; and
1-30 parts by weight of at least one nitrogen-containing plasticizer, the nitrogen-containing plasticizer is a compound or deep eutectic system having at least three nitrogen atoms.

2. The thermoplastic starch composition of claim 1, wherein the compound having at least three nitrogen atoms is one or more selected from a group consisting of arginine, guanidine, diethylenetriamine, triethylenetetramine, tetraethylenepentamine, 2-cyanoguanidine, bis(urea), melamine, tris(2-aminoethyl)amine, poly(allylamine) hydrochloride, polyether amine, polyamides.

3. The thermoplastic starch composition of claim 1, wherein the deep eutectic system having at least three nitrogen atoms is urea-based deep eutectic system.

4. The thermoplastic starch composition of claim 3, wherein the urea-based deep eutectic system is a binary system comprising a second compound; the second compound is a quaternary amine compound or a salt thereof.

5. The thermoplastic starch composition of claim 4, wherein the quaternary amine compound or a salt thereof is choline chloride or betaine.

6. The thermoplastic starch composition of claim 4, wherein the molar ratio of urea to the second compound in the binary system is in the range of 4:1 to 1:4.

7. The thermoplastic starch composition of claim 4, wherein the molar ratio of urea to the second compound in the binary system is in the range of 2:1 to 1:2.

8. The thermoplastic starch composition of claim 3, wherein the urea-based deep eutectic system is a ternary system comprising a second compound and a third compound, the second compound is a quaternary amine compound or a salt thereof or an amino acid, and the third compound is a polyalcohol selected from the group consisting of sorbitol, glycerol, sucrose, dextrose.

9. The thermoplastic starch composition of claim 8, wherein the quaternary amine compound or a salt thereof is choline chloride or betaine.

10. The thermoplastic starch composition of claim 8, wherein the amino acid is proline.

11. The thermoplastic starch composition of claim 8, wherein a molar ratio of the urea, the second compound to the third compound in the ternary system is in the range of 4:1:1 to 1:1:1.

12. The thermoplastic starch composition of claim 8, wherein a molar ratio of the urea, the second compound to the third compound in the ternary system is in the range of 3:1:1 to 1:1:1.

13. The thermoplastic starch composition according to claim 1, wherein the nitrogen-containing plasticizer is one or more selected from a group consisting of arginine, guanidine, diethylenetriamine, and urea-based deep eutectic systems when the thermoplastic starch composition is used for food contact applications.

14. The thermoplastic starch composition according to claim 1, wherein the starch-based material is natural starch, modified starch, or any combinations thereof.

15. The thermoplastic starch composition according to claim 1, further comprising:
1-20 parts by weight of oxygen-containing plasticizer, the oxygen-containing plasticizer is a C4-C8 oxygen-containing organic compound selected from the group consisting of acetal, acyl, alcohol, aldehyde, alkoxy, carboxyl, ester, ether, ketone, or any combination thereof;
1-20 parts by weight of one or more functional additives, selected from a waterproof agent, an antioxidant, a filler, a release agent, or any combination thereof.

16. The thermoplastic starch composition according to claim 1, wherein the oxygen-containing plasticizer is selected from the group consisting of glycerol, sorbitol, sugar alcohol, ethylene glycol, diethylene glycol, triethylene glycol, tetraethylene glycol, or any combination thereof.

17. The thermoplastic starch composition according to claim 1, wherein the thermoplastic starch composition comprises a bio-based carbon content higher than 60% according to standards ASTM D6866 or EN 16640; and/or the thermoplastic starch composition comprises a bio-based content of more than 60% according to standard EN 16785-1.

18. A thermoplastic composite, formed by compounding a thermoplastic starch composition according to claim 1 and a fossil-based plastic.

19. The thermoplastic composite according to claim 18, wherein the thermoplastic starch composition and the fossil-based plastic are in a mole ratio of no less than 1:1.

20. A food-contactable product made from a thermoplastic starch composition according to claim 1, the food contact product complies with standards GB/T 41220, GB/T 10457, GB/T 18006 or GB/T 10004.

21. A food-contactable product made from a thermoplastic composite according to claim 18, the food contact product complies with standards GB/T 41220, GB/T 10457, GB/T 18006 or GB/T 10004.
